(19) United States
(12) Patent Application Publication
(10) Pub. No.: US 2026/0056932 A1
(43) Pub. Date: Feb. 26, 2026

(54) SYSTEM AND METHOD FOR AUTOMATIC EVALUATIONS OF MACHINE LEARNING GENERATED DATA ITEMS

(71) Applicant: Actimize Ltd., Ra'anana (IL)

(72) Inventors: Kiran BATHULA, Mandamarri (IN); Danny BUTVINIK, Haifa (IL)

(73) Assignee: Actimize Ltd., Ra'anana (IL)

(21) Appl. No.: 18/812,422

(22) Filed: Aug. 22, 2024

(51) Int. Cl. G06F 16/23; G06F 18/2415

(52) U.S. Cl. CPC G06F 16/2365; G06F 18/2415

(57) ABSTRACT

A system and method for evaluating machine learning generated data items, including: generating, by a machine learning model, an output data item based on an input data item, where the output item represents or corresponds to the input item (e.g., the output item is a textual description of a non-textual input item); computing a similarity value between the output item and the input item; and performing an exchange of data between remotely connected computer systems (such as, e.g., sending or transmitting the output item, or a computerized command to update or retrain the machine learning model) based on a comparison of the computed similarity value to a benchmark similarity value.

### FIELD OF THE INVENTION

The present invention relates generally to machine learning technology, and more specifically to evaluating data items generated using machine learning models.

### BACKGROUND OF THE INVENTION

With the rapid advancement of machine learning models, large language models (LLMs), and generative artificial intelligence (GenAI) models, the ability to generate data items such as text, images, and audio has significantly improved. However, these models can produce outputs of varying quality, relevance, and accuracy, necessitating robust evaluation methods. Effective evaluation is crucial to ensure that the generated data items meet specific standards and are useful for their intended applications. Without proper evaluation, there is a risk of deploying models that generate erroneous, biased, or low-quality outputs, and/or that may not be updated or adjusted in time to produce desirable outputs, which can undermine the reliability and effectiveness of AI technologies. Therefore, developing systematic methods for evaluating these data items is essential to enhance model performance, maintain trustworthiness, and guide further improvements in AI research and applications.

In addition, in organizations such as, e.g., financial institutions, input data in formats such as JSON/.yaml/tabular data are used as a basis for reports, such as, for example, suspicious activity narratives (or SAR narratives) which are a critical part of financial crime detection and reporting. There is a need for methods to check that the report or text is in fact representative of contents of the input on which it was based (and does not include, e.g., erroneous details or contents).

### SUMMARY

Some embodiments of the invention may enable evaluating machine learning generated data items. Some embodiments may include generating, by a machine learning model, an output data item based on an input data item, where the output item represents or corresponds to the input item (e.g., the output item is a textual description of a non-textual input item); computing a similarity value between the output item and the input item; and performing an exchange of data between remotely connected computer systems (such as, e.g., sending or transmitting the output item, or a computerized command to update or retrain the machine learning model) based on a comparison of the computed similarity value to a benchmark similarity value.

Some example embodiments may allow generating reliable suspicious activity reports of desirable quality based on inputs from suspicious activity databases or tabular data.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments are illustrated without limitation in the figures, in which like reference numerals may indicate corresponding, analogous, or similar elements, and in which:

FIG. 1 is a high-level block diagram of an exemplary computing device which may be used with embodiments of the present invention;

FIG. 2 shows example computer systems remotely connected by a data network according to some embodiments of the invention;

FIG. 3 shows an example comparison between embeddings in a 2-dimensional space according to some embodiments of the invention;

FIG. 4A-B shows an example system for evaluating machine learning generated data items according to some embodiments of the invention;

FIG. 5 is a flow diagram showing a first example process of evaluating machine learning generated data items according to some embodiments of the invention;

FIG. 6 is a flow diagram showing a second example process of evaluating machine learning generated data items according to some embodiments of the invention;

FIG. 7 shows example procedures for calculating benchmarks or thresholds according to some embodiments of the invention;

FIG. 8 shows an example evaluation procedure combining different metrics according to some embodiments of the invention;

FIG. 9 shows example data structures which may be used by or included in some embodiments of the invention;

FIG. 10 shows an example user interface for generating suspicious activity reports according to some embodiments of the invention;

FIG. 11 is a flowchart showing an example process for evaluating data items generated using a machine learning model according to some embodiments of the invention.

FIG. 12 shows an example monitoring and improvement mechanism according to some embodiments of the invention; and

FIG. 13 shows an example generative artificial intelligence (GenAI) model service improvement process according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, components, modules, units and/or circuits have not been described in detail so as not to obscure the invention.

Some embodiments of the invention may allow generating or producing-using machine learning models such as for example generative artificial intelligence or large language models-detailed descriptions or summaries of input items in different formats. For example, some embodiments may be used to generate or produce human unreadable data items, converting for example computer executable files or complex database records, into a human readable text output describing the input. Embodiments may assess or quantify to what extent a textual description or summary (which may, e.g., be generated by a machine learning model) corresponds to or represents a corresponding file or input (e.g., the input based on which the description was generated or produced), by calculating various quality metrics and/or based on appropriate conditions or criteria. Some embodiments may allow updating or retraining machine learning models based on calculated metrics or statistics of metric values.

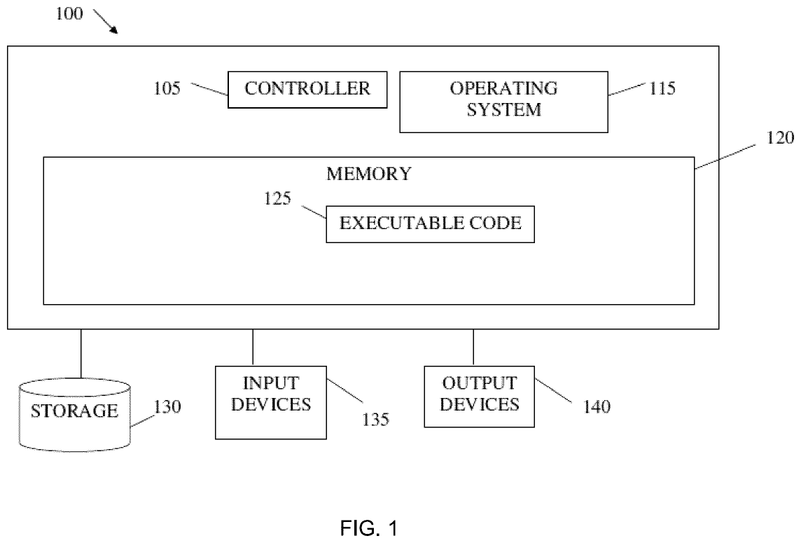

FIG. 1 shows a high-level block diagram of an exemplary computing device which may be used with embodiments of the present invention. Computing device 100 may include a controller or computer processor 105 that may be, for example, a central processing unit processor (CPU), a chip or any suitable computing device, an operating system 115, a memory 120, a storage 130, input devices 135 and output devices 140 such as a computer display or monitor displaying for example a computer desktop system.

Operating system 115 may be or may include code to perform tasks involving coordination, scheduling, arbitration, or managing operation of computing device 100, for example, scheduling execution of programs. Memory 120 may be or may include, for example, a Random Access Memory (RAM), a read only memory (ROM), a Flash memory, a volatile or non-volatile memory, or other suitable memory units or storage units. Memory 120 may be or may include a plurality of different memory units. Memory 120 may store for example, instructions (e.g. code 125) to carry out a method as disclosed herein, and/or output data, etc.

Executable code 125 may be any application, program, process, task, or script. Executable code 125 may be executed by controller 105 possibly under control of operating system 115. For example, executable code 125 may be or execute one or more applications performing methods as disclosed herein. In some embodiments, more than one computing device 100 or components of device 100 may be used. One or more processor(s) 105 may be configured to carry out embodiments of the present invention by for example executing software or code. Storage 130 may be or may include, for example, a hard disk drive, a floppy disk drive, a compact disk (CD) drive, a universal serial bus (USB) device or other suitable removable and/or fixed storage unit. Data described herein may be stored in a storage 130 and may be loaded from storage 130 into a memory 120 where it may be processed by controller 105.

Input devices 135 may be or may include a mouse, a keyboard, a touch screen or pad or any suitable input device or combination of devices. Output devices 140 may include one or more displays, speakers and/or any other suitable output devices or combination of output devices. Any applicable input/output (I/O) devices may be connected to computing device 100, for example, a wired or wireless network interface card (NIC), a modem, printer, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods and procedures disclosed herein.

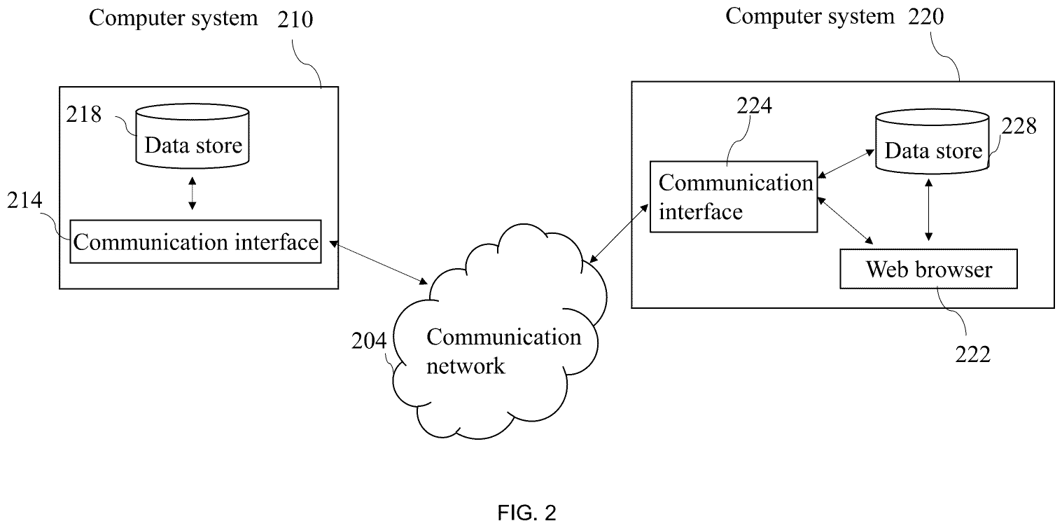

FIG. 2 shows example computer systems remotely connected by a data network according to some embodiments of the invention.

Some embodiments of the invention may include performing an exchange of data or data transfer between remotely connected computer devices. For example, remote computer 210 may send or transmit, over communication or data network 204, computerized data items, data elements, or data points of information such as for example application programming interface (API) calls, large language model prompts, suspicious activity reports or alerts, e.g., including calculated scores or metrics, as well as additional computerized commands or requests—to computerized system 220, and/or vice versa. Each of systems 210 and 220 may be or may include the various components described with reference to system 100, as well as other computer systems, and include and/or operate or perform, e.g., the various corresponding protocols and procedures described herein. In some embodiments, computerized systems 210 and 220 may additionally perform a plurality of operations including for example sending and/or transmitting and/or collecting and/or receiving additional data to or from additional remote computers systems. One skilled in the art may recognize that additional and/or alternative remote and/or computerized systems and/or network and connectivity types may be included in different embodiments of the invention.

In some embodiments of the invention, computer systems 210 and 220 may communicate via data or communication or data network 204 via appropriate communication interfaces 214 and 224, respectively-which may be for example NICs or network adapters as known in the art. Computerized systems 210 and/or 220 may include data stores such as, e.g., 218 and 228 which may for example include a plurality of received data items, messages, requests, reports, and the like.

Some embodiments of the invention may include generating, by a machine learning model, an output data item based on an input data item, and evaluating the output data item and/or determining whether the output data item represents or matches the input data item. Some embodiments may include performing evaluations on output data items using metrics such as for example described herein.

Representing the result of evaluation of text as metrics according to some embodiments of the invention may be used to assess and quantify the quality of machine learning (ML), artificial intelligence (AI), large language models (LLMs) and generative AI (GenAI) generated items and/or texts, and to track the performance of the gen AI service and improve it iteratively, for example by optimizing GenAI models or LLMs based on the metrics such as for example described herein.

In some embodiments, input data items may be in various formats such as JSON, .yaml, tables, or CSV files, and outputs may be, e.g., in string/text format. In order to obtain vectors or vector embeddings of an input such as, e.g., a structured data input (or a structured database entry), some embodiments may convert the input into a string format (e.g., using a context or explanation prompt). Some machine learning and/or embedding models according to some embodiments may be able to infer the structure of the data from strings; other models according to some embodiments may be able to use inputs of different formats, such as for example JSON or CSV files, and the like.

As part of evaluating texts and/or models, some embodiments may include calculating benchmark metrics to which text or model evaluations may be compared. Comparisons to benchmarks or benchmark metrics according to some embodiments of the invention may help determine the quality of a given text and/or model. For example, if a metric, score or similarity score (see further description herein) is higher than a benchmark score or threshold, a given text or summary may be determined to be of “good” quality (and may simply be referred to as “good” herein). Conversely, if the score or similarity score lower than the benchmark, then the text summary may be determined to be of “bad” quality. Quality as used herein, as well as the metrics provided herein, may be a measure indicative of the generated data item representing or matching the input item. For example, and as further demonstrated herein, a GenAI generated summary of an input text may be determined similar to the input text (or, e.g., as a “good” summary of the input text), or dissimilar to that text (e.g., a “bad” summary of that text) based on metrics such as for example described herein.

In some embodiments, average scores or similarity scores calculated for a plurality of texts or inputs may be compared against a given benchmark, for example to assess the overall quality of text generation and/or to determine whether improvements may be needed to the corresponding generative model. Benchmarks according to some embodiments may be used at the time of development, and/or to evaluate on-going generation in production or deployment environments.

Some or all of the operations or procedures described herein may be performed in real time, e.g., as an automated response to texts generated by a given model, which may automatically be used as inputs according to some embodiments of the invention.

Some metrics according to some embodiments may include comparing vector embeddings or representations of the input and output data items, such as for example described herein.

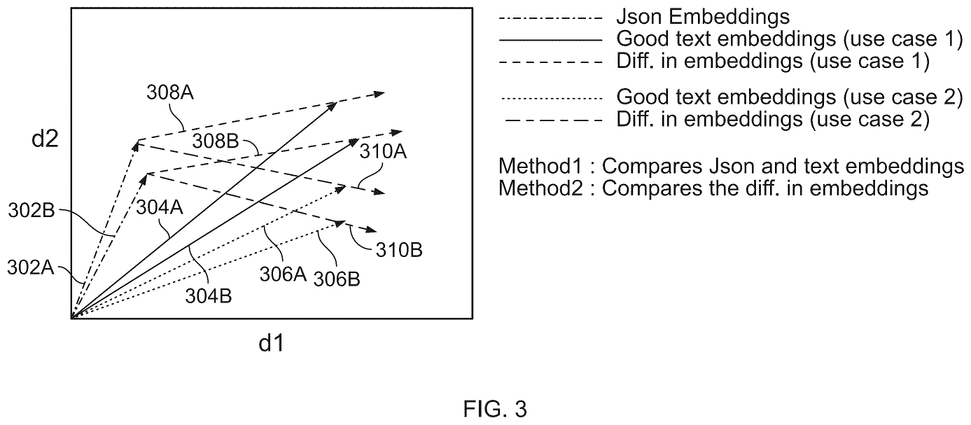

FIG. 3 shows an example comparison between embeddings in a 2-dimensional space according to some embodiments of the invention.

Elements 302A-B show embeddings calculated for two input data items or texts. Elements 304A-B and 306A-B show embeddings calculated for two output data items corresponding to the input data items using, e.g., two different data item generation processes (which may include, for example, using different prompts in each generation process) In some embodiments, output data items may be generated using a GenAI model based on the input item such as for example described herein. Vector embeddings may generated or calculated using a vector embedding model such as for example described herein. Elements 308A-B and 310A-B show differences or distances between embeddings for the input items and the embeddings for the generated data items using, e.g., the first and the second output data item generation processes respectively. As further described herein, some embodiments may include comparing metrics such as, e.g., similarities or distances between the embeddings of the input item and the corresponding generated item (e.g., comparing elements 302A and 304A). Some embodiments may include comparing similarities or distances between the difference in embeddings of the input data item and the embeddings of the output or the generated item (e.g., elements such as for example 308A-B)—for example with an appropriate benchmark or reference.

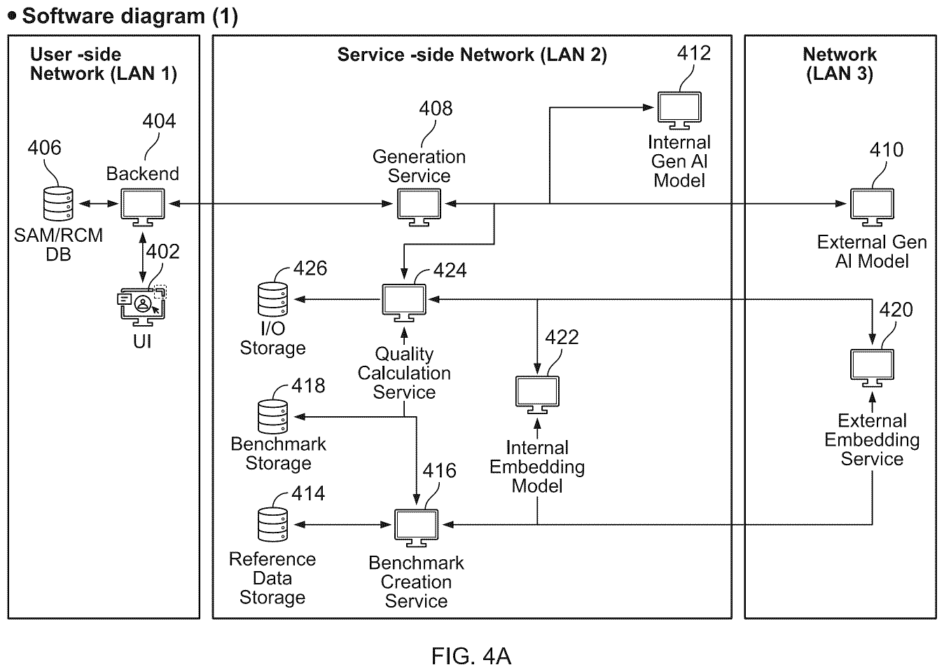

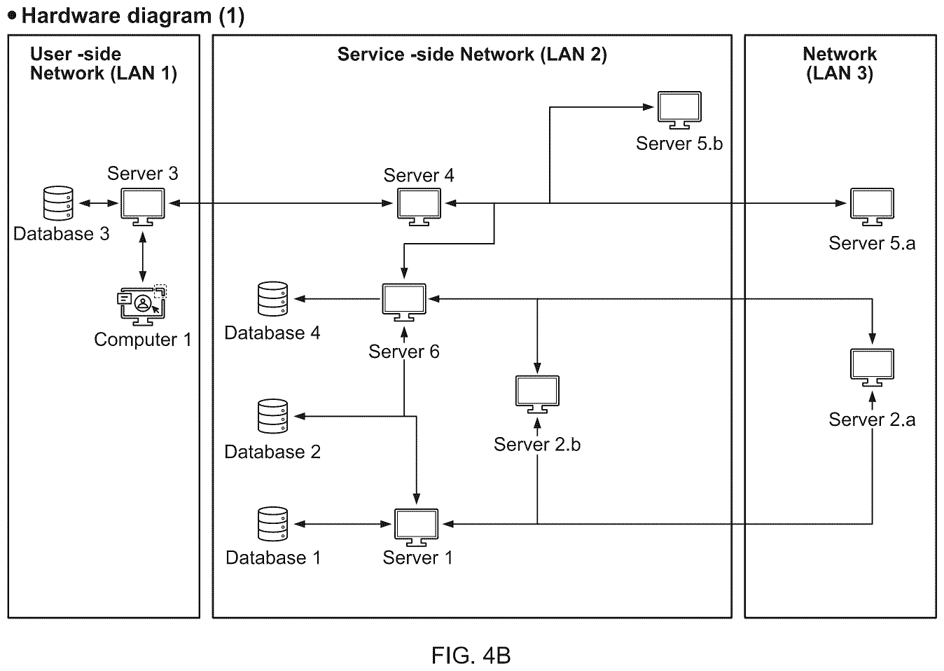

FIG. 4A-B shows an example system for evaluating machine learning generated data items according to some embodiments of the invention.

According to some embodiments, a system may include some or all of following components.

User interface (UI) 402 which may be for example implemented using the ActOne UI framework by NICE Ltd, e.g., of a user's portal or service which may be used on internet browser for example by an investigation agent. The user may interact in human language with a chat or chatbot component included in this component, and/or may click on a button using which the user may request to generate text for cases like SAR narratives (see further description herein). Example hardware it may execute on includes computer 1, e.g., via Internet Browsers such as for example Google Chrome, Mozilla Firefox, Microsoft Edge, and the like.

Backend Service 404 which may be a backend service responsible for communications between the UI and the GenAI service (may be for example implemented using the ActOne framework). It may for example receive a request for a generative task from UI, look up a corresponding database for additional info (such as for example transaction details in the case of SARs), and send an appropriate call to the relevant generative component or service (for example using an API call for the relevant component). Once it receives a response from the generative service it may save it in a dedicated database. Example hardware it may run on may execute on includes server 3 which may be for example a computer or virtual machine (VM) running a Linux/Windows operating system (OS) with a Java virtual machine (JVM).

Suspicious activity monitor (SAM)/risk case management (RCM) client database 406, which may be, e.g., a relational database responsible for storing data related to alerts in the system. It may store data related to the alerts such as the entity against which the alert is generated, metrics, results and/or scores, different rules and/or programs or components for detecting for fraud and suspicious activity, details of investigation processes and their outcomes, and details and/or contents of SAR forms. Example hardware it may execute on may include database 3 which may for example be hosted on a valid version of a Microsoft structured query language (SQL) or Oracle database server. It may be used by the backend process to query for additional information such as, e.g., noted herein.

Generation service 408, which may be a machine learning, LLM or GenAI component or service running, e.g., on a server on the server side network (LAN2). It may receive inputs from the user, e.g., via the backend service, may include or call a generative AI model or service (e.g., using a corresponding API) and may return a generated output or response to the user. It may also store the input received and the output generated for example in a data storage, and/or may trigger the calculations of metrics according to some embodiments such as for example described herein. Example hardware it may execute on may include server 4 which may be a computer/VM running a Linux/OS including python integration or support and/or a JVM.

External GenAI model or service 410, which may be an internal component or service that may perform various generative tasks such as for example generating output data items based on corresponding inputs such as for example described herein. This may be, for example, an external component or service with which other components may communicate, e.g., using an API call. In some embodiments, a GenAI model or service may include a plurality of generative AI agents that may have access to various hardware, software and/or generative tools—and that may handle requests for text or output generation and may calculate or generate a plan and reasoning to use the tools and create outputs, responses or follow up questions to the user, which may include, for example:
i. Creating a plan that includes the usage of the tools available to the AI agent.
ii. Creating the inputs to be sent to the tools.
iii. Processing the output of the tools.
iv. Adapting or optimizing the plan based on the output from the tools, e.g., to produce outputs of improved quality (e.g., using reinforcement and/or supervised learning techniques).
v. Creating responses and follow up questions to the user in human language.

Example hardware it may execute on may include server 5.a which may be computer/VM running a Linux/Windows OS with python and or a JVM on a vendor side network (LAN 3).

Internal Gen AI model or service 412 may be an internal component or service that may perform various generative tasks such as for example generating output data items based on corresponding inputs such as for example described herein. In some embodiments, it may include or involve the use of AI agents and/or generating a plan and reasoning to use various tools and create responses or follow up questions to the user, which may include, for example:
i. Creating a plan that includes the usage of the tools available to an AI agent.
ii. Creating the inputs to be sent to the tools.
iii. Processing the output of the tools.
iv. Adapting or optimizing the plan based on the output from the tools, e.g., to produce outputs of improved quality (e.g., using reinforcement and/or supervised learning techniques).
V. Creating responses and follow up questions to the user in human language.

Example hardware it may execute on may include server 5.b which may be computer/VM running a Linux/Windows OS with python and or a JVM on server-side network (LAN 2)

In some embodiments, external and internal Gen AI models and/or services may be or may be used as alternatives to each other. At any point only one of them may be used.

Reference data storage 414 may be a data/file storage system on service side network LAN2. It may store several pairs of inputs with structured formats such as JSON/.yaml/tabular and the textual outputs or summaries that are determined good for a given use case. This component may be implemented using, e.g., an S3 bucket (e.g., database 1).

A benchmark creation service 416 may be a service on server side network LAN2. It may calculate, e.g., benchmark or reference thresholds and vectors and stores them in the benchmark storage. Example hardware it may execute on may include server 1 which may be a computer/VM running a Linux/Windows OS with python and or a JVM.

Benchmark storage 418 may be a database for embeddings and thresholds. This component may store or contain, e.g., embeddings created by benchmark creation service. This component may be implemented using, e.g., an S3 bucket (e.g., database 2).

External embedding model or service 420, which may be an external LLM service (requested, e.g., using an appropriate API) for an embedding model or for calculating embeddings or vector representations according to some embodiments of the invention. It may receive an input, e.g., in the form of a text and may return the embedding(s) or vector(s) representing that input. Example hardware it may execute on may include server 2.a which may be computer/VM running a Linux/Windows OS with python and or a JVM on a vendor side network (LAN 3)

Internal embedding model service 422 may be an internal embedding model or LLM. It may receive an input, e.g., in the form of a text or a non-textual item, and may return the embedding(s) or vector(s) representing that input. Example hardware it may execute on may include may be server 2.b which may be computer/VM running a Linux/Windows OS with python and or a JVM on a server-side network (LAN 2).

In some embodiments, the external and internal embedding models or services may be or may be used as alternatives to each other. At any point only one of them may be used.

Quality calculation service 424 may be or may include a program or service running on server side network (LAN2). It may receive a pair of, e.g., a structured input (e.g., non-textual) and a text output from generation service, and may calculate scores or metrics such as for example described herein, and may write the metrics to the I/O storage. Example hardware it may execute on may include server 6 which may be a computer/VM running a Linux/OS with python and or a JVM.

I/O storage 426 may be a storage component or service on server side network (LAN2). It may store the structured input and the output, as well as the calculated quality metrics.

According to some embodiments, some components and/or computer systems included in FIG. 4A-B may be connected over a public network such as for example the internet, or using a private network and/or secure connection. Additional or alternative components and connectivity between them may be included in different embodiments.

Some embodiments may include generating, by a machine learning model, an output data item based on an input data item, the output item representing the input item.

To generate data items based on input data items using a machine learning model, LLM, or GenAI model, some embodiments may include receiving the input data items in various formats such as for example JSON, text, or non-textual format (although different formats such as, e.g., images, or audio may be used in different embodiments). The received items may then be standardized and, e.g., pre-processed which may involve normalization, tokenization, or feature extraction to make the data compatible with the model. The pre-processed data may be fed into the model, which may be, e.g., a model trained on a comprehensive dataset of appropriate files or data items to understand patterns and correlations within the relevant data. In some embodiments a model may be trained on large volumes of data available publicly such as data available on the internet such as for example in public databases, and may be used without further fine-tuning—while in other embodiments the model may be fine-tuned using labelled data of specific use cases or domains, where labelled data may contain, e.g., inputs and outputs that are considered desirable, relevant, or appropriate for the respective input. In some embodiments, models may be trained without labelled data using continued pre-training techniques, where data may not be labelled. The model may process the input through its multiple layers (which may be for example deep neural network layers), and may transform the input data to generate new data items-which may include the model applying, for example, context-specific transformations and computations. For instance, an LLM may generate text, or new text outputs, by predicting the next word or sentence based on the input context and already generated parts of the outputs; a GenAI model may create outputs that resemble inputs in style and content, and the like. In some embodiments, text generation may be performed or executed one token at a time, and the model may use an attention mechanism, e.g., across many neural network layers, to account for weights/importance of different words/tokens within the input (which may be referred to as context-specific information) as part of generating of next token in each iteration or generation operation. In some embodiments, post-processing may be applied to the generated data items to refine and enhance their quality, which may include ensuring they meet the desired standards. For example, some embodiments may scan and/or remove undesirable contents, such as for example potential personally identifiable information (PII), or additional contents from generated data items or outputs, and/or edit or structure generated text or outputs into a predefined structure or file format. Finally, newly generated output data items may be transferred or transmitted to relevant consumer or destination modules or components, and may be used for performing evaluations and/or calculating metrics such as for example described herein. Various LLM or GenAI model architectures may be used in different embodiments of the invention.

While some embodiments use human readable text or text based data items as an example, different embodiments may include input or output data items not limited to ones including text or human readable text. In one example, input data items may be, for example, computer executable files including computer readable commands, and output data items may be, e.g., modified versions of such executable files (for example including modifications and/or different commands, e.g., in a different programming language, and/or suitable for a different OS, which may be requested in a prompt to a GenAI model or component). Additional or alternative example data items may be used in different embodiments.

Some embodiments may include generating embeddings for an input data item and an output generated by a GenAI or LLM, for example using a vector embedding or Doc2Vec model. For example, a vector embedding model may receive data items, which may be for example a JSON, non-textual items (such as for example a structured dataset entry or item, or table data, which may not be a paragraph or unit of text in natural language), or generated text (additional data types including, e.g., image, or audio may be included in some embodiments). Received data may be pre-processed which may include, e.g., steps of tokenization, normalization, feature extraction, and the like, to ensure compatibility with the embedding model. Pre-processed data may be fed into a vector embedding or Doc2Vec model, trained, e.g., on a large corpus or texts or JSON data to capture semantic relationships within the data. The embedding model may then process the data, and may convert it into a dense, high-dimensional vector representation (e.g., embedding) that encapsulates its semantic meaning. Calculated or generated embeddings, for the input and the generated output, may be obtained by passing the respective data items through the layers of the embedding model, which applies learned transformations to map them into a shared vector space. This may result in two dense vector representations that can be compared, analyzed, or used in downstream tasks such as similarity measurement such as for example described herein, as well as clustering, or further machine learning processes. The calculated or generated embeddings may be transmitted or delivered to other system components, e.g., to be used in assessments and/or similarity calculations such as for example described herein.

In some embodiments, an input data item may be passed through a GenAI or LLM to generate an output, and the input and/or output may be also pre-processed simultaneously. The output may then be fed into the same embedding model to generate its corresponding embedding or embeddings.

Some embodiments may use embedding models that may be fine-tuned on data specific to the domain and use cases for which data item generations and/or evaluations may be needed. Some embedding, or Doc2Vec models which may be used in some embodiments may be or may include for example, BERT-based models, GPT-2 based models, the text-embedding-3-large models or text-embedding-3-small family of embedding models by OpenAI, and the like. In some embodiments, relevant embedding models may be trained using a labelled dataset of inputs and their condensed, generated or summarized counterparts (including, e.g., summaries labeled as “good” or as “bad” summaries, and/or outputs associated with numeric scores)—to generate or compute embeddings for inputs and outputs such that, e.g., a pair embeddings for an input and an output may be compared (e.g., using a similarity score or formula) in cases where the output is significantly different from the input (e.g., in a case where the output may be 3 pages long and the input may be 300 pages long, or where the input and the output differ in additional or alternative characteristics or properties). Additional or alternative models may be used in different embodiments.

In some embodiments, the generating of an output data item based on an input data item comprises adding a predefined context prompt to the input data item.

Some embodiments may include or add an explanation or context string or prompt, which may for example be a prefixed or predetermined string or prompt, to a structured database entry or to an input item—for example, to link between structured data and a corresponding text data item. In such manner machine learning or embedding model may associate the two strings or calculate comparable embeddings for the two items. Some parts of an explanation string may contain parts and or phrases from the prompts used to generate the text using the models. For example: in a nonlimiting example case where the data, which may be an input in JSON format, includes details of a customer of a bank, and a where prompt may be used for instructing the model to interpret the JSON input data as corresponding to a bank's customer, an explanation prompt, string, or text may be or may include, e.g., “the bank's customer details are “or “bank Customer details:” which may then followed by the input data in JSON format. Additional or alternative explanation strings, prompts or texts may be used in different embodiments.

Some embodiments may include computing a similarity value between the output item and the input item. In some embodiments, the computing of a similarity value comprises calculating a cosine similarity between a vector representation of the output data item and a vector representation of the input data item.

For example, some embodiments of the invention may determine a similarity between vectors or vector embedding—e.g., between an embedding representing an input data item and an embedding representing its corresponding output data item. In some embodiments, this may be done based on distances or the angles between the vectors or embeddings. In some embodiments, the cosine similarity or distance formula or function, which may consider an angle between the two vectors, may be used. The smaller the angle between the two vectors, the higher the cosine similarity may be. When the angle between the two vectors is zero and, e.g., the two vectors are parallel and/or point in the same direction—the cosine similarity function or a different, appropriate function may reach its maximum; it may reach zero when the vectors are orthogonal and may be −1 when the vectors are parallel but point in opposite directions.

An example cosine similarity or distance formula which may be used in some embodiments is given in Eq. 1:

$$cosine\_similarity = cos ( θ ) = ( A \cdot B ) / ( ‖ A ‖ ‖ B ‖ ) . \qquad Eq . 1$$

where A. B represents the dot product of vectors A and B (the dot product may be calculated as the sum of the products of the corresponding entries of the two sequences of numbers); ∥A∥ and ∥B∥ represent the magnitude (or length) of each of vector A and B, respectively (which may be calculated as the square root of the sum of the squares of a given vector's components); and θ which may be the angle between the two vectors A and B in the relevant multi-dimensional space. Additional or alternative similarity calculations or computations may be used in different embodiments of the invention.

In some embodiments, the input data item comprises a structured database entry. According to some embodiments, a structured database entry may be provided into a GenAI or LLM—for example with a context or explanation string or prompt-to generate a text summary or description of the database entry, such as for example demonstrated in Table 1. Additional or alternative example inputs and corresponding generations of outputs may be considered in different embodiments.

Table 1 shows example input JSONs, example generated texts, and example scores which may be calculated according to some embodiments of the invention:

TABLE 1

| | Input Data | Generated Data | | Example |
|---|---|---|---|---|
| | (JSON) | (Text) | Role/Description | Score |
| 1. | “{‘name’: ‘Adam Smith’, | Adam Smith is | This may be a used | 1 |
| | ‘address’: ‘44-2, old street, | a 34 year old | reference pair which | |
| | 44-2, old street, Ohio’, | professional | may be used as a | |
| | ‘occupation’: ‘professional | athlete who | benchmark against | |
| | athlete’, ‘age’: 34}”, | lives at 44-2, | which other scores | |
| | | old street, | may be compared | |
| | | Woodstock, | | |
| | | Ohio. | | |
| 2. | ‘name’: ‘harry potter’, | harry potter is a | This pair may be | 0.91939455 |
| | ‘address’: ‘44-2, old street, | 76 year old | evaluated. The score | |
| | 44-2, old street, New York’, | professional | indicates a good | |
| | ‘occupation’: ‘professional | athlete who | correspondence | |
| | athlete’, ‘age’: 76 | lives at 44-2, | between the | |
| | | old street, | text/summary | |
| | | Woodstock, | | |
| | | New York | | |
| 3. | ‘name’: ‘Adam Smith’, | Harry Potter is a | This pair may be | 0.74712689 |
| | ‘address’: ‘44-2, old street, | 76 year old | evaluated. The score | |
| | 44-2, old street, Ohio’, | lawyer who | indicates | |
| | ‘occupation’: ‘professional | lives at 72A, | text/summary quality | |
| | athlete’, ‘age’: 34 | beach view, | lower than that of 1. | |
| | | Sutton, Ohio | Has good structure | |
| | | | but the information is | |
| | | | not correct | |
| 4. | “{‘name’: ‘Adam Smith’, | This is a short | This pair may be | 0.389148 |
| | ‘address’: ‘44-2, old street, | text but is still | evaluated. The score | |
| | 44-2, old street, Ohio’, | totally | indicates this is a bad | |
| | occupation’: ‘professional | unrelated. This | text/summary. Text is | |
| | athlete’, ‘age’: 34}”, | should get a low | totally irrelevant to | |
| | | similarity score. | the input JSON | |

The various examples in Table 1 demonstrate that scores or metric that may be calculated according to some embodiments of the invention may be used to determine whether an output data item represents, corresponds, or may be similar to its corresponding input item. In the nonlimiting example provided in Table 1, input items may be database entries, and output items may be written descriptions of the input database entries. A high calculated score or metric may indicate high correspondence, e.g., that the output item, or output text, is highly similar to the input item (which may be, e.g., non-textual or which do not correspond to a unit of text in natural language)—and that the output item therefore adequately “represents” its input counterpart item. Accordingly, high scores may determine or indicate that the output may item be used instead of the input, may replace the input, and the like (and may be considered a “good” textual description or summary of the input). Lower scores may indicate a mismatch, or a lack of correspondence between the input and output data items-such as, e.g., that the output includes information not included in the input data item, and/or does not include information included in the input, and the like (and may therefore be considered a “bad” representation, or a bad summary of the input). In this particular example, the threshold separating between good and bad scores may be, e.g., 0.9—although additional or alternative thresholds or methods/procedures for determining thresholds may be used in different embodiments (see further description herein). Additional or alternative examples using different data items may be considered using different embodiments.

Some embodiments may include or involve calculating a plurality of scores or metrics. or metrics for evaluating items generated for an input data item (which may be, e.g., in a structured format such as for example in JSON/YAML or a table format) by a machine learning model, for example using the various methods and/or procedures described herein. Some embodiments may provide various methods to calculate and/or compare metrics such as, e.g., described herein. Some example methods and/or metrics may be denoted “Metric_1”, “Metric_2”, and the like. Some example methods or procedures described herein may be combined into a single, unified method or procedure, or be performed separately or independently from other methods or procedures.

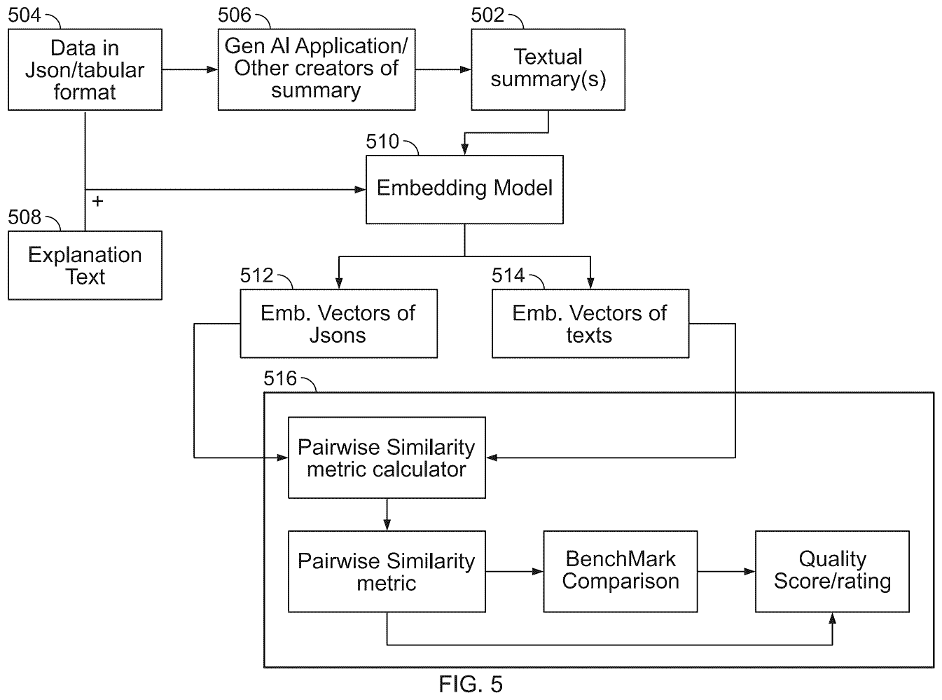

FIG. 5 is a flow diagram showing a first example process of evaluating machine learning generated data items according to some embodiments of the invention.

Following the generating of an output data item or textual summary (element 502) based on an input data item such as for example dataset entries or data in in JSON/tabular format (element 504) using a machine learning model such as, e.g., a GenAI model (element 506), embodiments may provide the data items, e.g., with an explanation string (element 508) to an embedding model (element 510) to generate embeddings for the input items or JSONs (element 512) as well as for output items or texts (element 514) and calculate Mertic_1 (element 516) such as, e.g., described herein.

Metric_1: to calculate this metric, some embodiments may calculate, by a vector embedding model, a plurality of vector embeddings for, or based on, input data and its generated counterpart, which may be for example a generated textual summary of the input or a different generated data item. Some embodiments may then calculate a similarity between the resulting vector embeddings. The calculated similarity score may then be used “as—is”, e.g., without further modifications—or be compared against a benchmark such as for example described herein-to produce a final score for the output data item under consideration.

In some embodiments, calculations of scores may be performed offline, may include or involve the following operations:

According to some embodiments, when a new input and output pair of text needs to be evaluated:
1: Embeddings or vectors of the input data item and a corresponding output data item (which may be for example a text produced by a GenAI model) may be calculated;
2: A similarity between the two vectors or embedding may be calculated;
3: A comparison between the calculated similarity or metric and a corresponding benchmark may be computed.

According to some embodiments, when a given GenAI model or generation approach needs to be evaluated, the following example operations may be performed, e.g., for each pair of new input and its generated counterpart:
1: Calculate embeddings of the input and its generated counterpart (e.g., a text generated by the relevant GenAI being evaluated);
2: Calculate the similarity of the embeddings of the input and the output pair;
3: Calculate an average value of all the calculated similarities of all pairs considered;
4: Compute a comparison of the calculated average with a corresponding benchmark.
5: If the average falls lower than the benchmark or threshold, it may be determined that the GenAI model is to be improved or adjusted-which may be performed such as, e.g., further described herein.

Additional or alternative operations or procedures may be included in different embodiments of the invention.

To track the performance of the generation process in production, some embodiments may calculate the average of the metric 1 for newly generated input and text pairs and may track of scores and/or comparisons over time.

In some embodiments, if scores or average scores fall below the benchmark or pre-set threshold, an alert may be generated and/or sent or transmitted regarding the drop in the metric and/or the need for improving the relevant model.

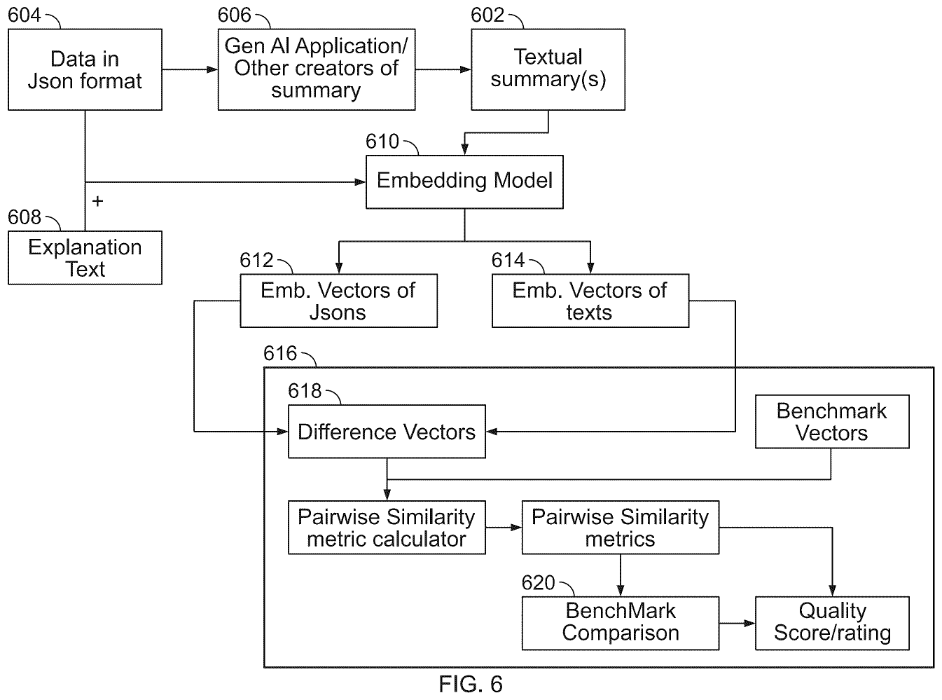

FIG. 6 is a flow diagram showing a second example process of evaluating machine learning generated data items according to some embodiments of the invention.

Following the generating of an output data item or textual summary (element 602) based on an input data item such as for example dataset entries or data in in JSON/tabular format (element 604) using a machine learning model such as, e.g., a GenAI model (element 606), embodiments may provide the data items, e.g., with an explanation string (element 608) to an embedding model (element 610) to generate embeddings for the input items or JSONs (element 612) as well as for output items or texts (element 614) calculate Mertic_2 (element 616) such as, e.g., described herein.

Metric_2: According to some embodiments, a difference between Metric_2 and Metric_1 described herein may be that Metric_2 may be calculated based on the similarities of a difference vector 618 between the newly generated text and its input data—and, e.g., between benchmark or reference difference vectors 620 which may be calculated by some embodiments and/or already established offline. In a nonlimiting example case where an embedding for an input is V₁=[1,2,3] and an embedding for an output is V₂=[4,5,6], a difference vector may be V₂₋₁=[(4-1), (5-2), (6-3] =[3,3,3]. A similarity value between V₂₋₁ and a reference vector of V_{ref}=[1,1,1] may then be compared, e.g., using a cosine similarity formula.

According to some embodiments, a score or metric for the newly generated text may be a function of the calculated similarities to the benchmark vectors. For example, the function may be a max (x,y, . . . ) function, avg (x,y, . . . ) function, min (x,y, . . . ) function, and the like, for example depending on the quality level required (in some embodiments higher metrics may, e.g., imply a higher standard for the generated items or generative model).

In some embodiments, the computing of a similarity value comprises computing a difference vector between the vector representation of the output item and the vector representation of the input item and comparing the computed difference vector to one or more reference vectors.

In order to calculate the Metric_2 and evaluate items and/or text and/or a generative model based on this metric, some embodiments may perform or may include or involve the following operations:

According to some embodiments, whenever, e.g., a new item or text is generated from an input and it needs to be evaluated.
1: Embeddings or vectors of the input and the generated output may be calculated;
2: A difference vector between the calculated embeddings or vectors may be calculated;
3: A similarity or a plurality of similarities between the calculated difference vector and one or more difference vectors in a benchmark or reference vector set may be calculated;
4: Metric 2 may be calculated as a function of the calculated similarities, where the function may be for example a max/min/avg function;
5: If metric 2 is above a benchmark or threshold value (such as, e.g., a value of 0.7), then the item or text may be determined to be “good”, and if not then the text may be determined as below par or “bad”.

According to some embodiments, any time a new GenAI model or generation approach needs to be evaluated, the following example operations may be performed, e.g., for each pair of new input and its generated counterpart:
1: Calculate Metric_2 for each pair;
2: Calculate an average of all the calculated values of metric_2 for all pairs considered;
3: Calculate or compute a comparison value between the calculated average and a corresponding benchmark.
4: If the average falls lower than the benchmark or threshold, it may be determined that the GenAI model is to be improved or adjusted-which may be performed such as, e.g., further described herein.

Additional or alternative benchmark or score calculation operations or procedures may be included in different embodiments of the invention.

In order to track the performance of a given item or text generation process by a generative model, e.g., in production or deployment environments, some embodiments may periodically calculate metrics such as, e.g., the average of the Metric_2 for newly generated input and text pairs—and for example track calculated score or metrics over time.

In some embodiments, if scores or metrics fall below a corresponding benchmark or threshold (which may be a separate or another pre-set or predetermined threshold), an alert may be generated and/or sent or transmitted regarding the drop in the metric and/or the need for improving the relevant model.

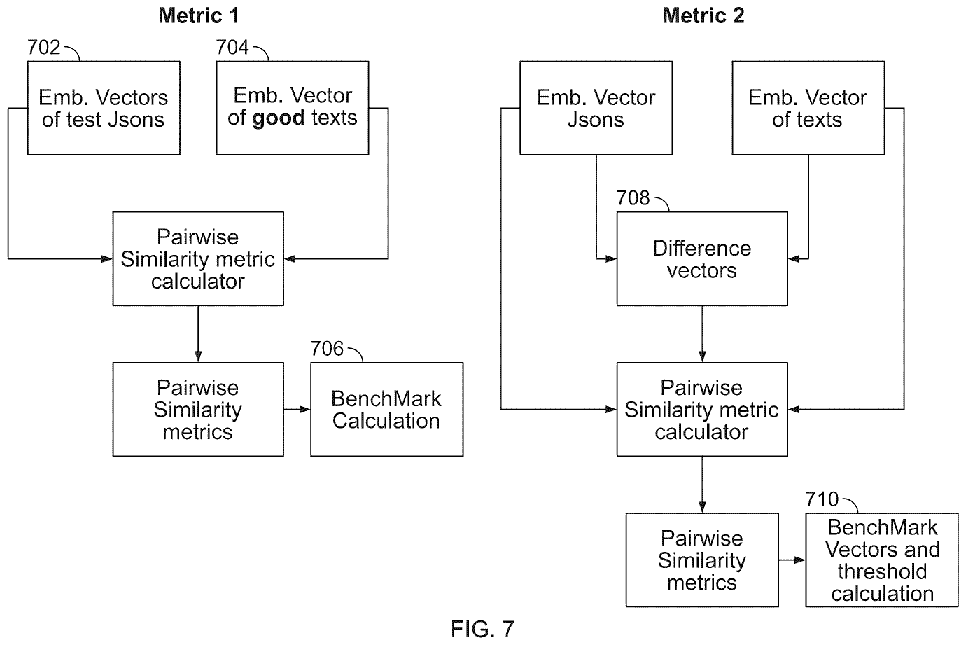

FIG. 7 shows example procedures for calculating benchmarks or thresholds according to some embodiments of the invention.

For calculating a benchmark, e.g., for Metric_1, some embodiments may calculate similarities between several pairs of input data (element 702) and their generated counterparts or summaries (for example, pairs used for benchmark calculations may be assumed or already determined to include an output data item being a “good” or adequate representation of its corresponding input; element 704). Some embodiments may calculate statistics based on calculated scores, such as for example minimum, maximum, or average values of scores or values calculated for the relevant pairs, and may use one or more of these statistical values as benchmarks or benchmark values (for example, the average score may be determined or used as a benchmark; element 706).

A benchmark for, e.g., Metric_2, may be or may include a set of vectors and/or thresholds, where each vector may be a difference between the embedding or vector of input and the embedding or vector of corresponding generated item or text (element 708). Some embodiments may include determining, computing, calculating or establishing a benchmark or threshold which may be calculated as the min/max/average of the similarities of all possible vector pairs in the benchmark (element 710). According to some embodiments, there may be any number of such vectors in a benchmark vector set for Metric_2 (such as for example 100 vectors in a set; however, for the sake of computation efficiency and since, e.g., the computational cost scaling of calculating similarities between all possible pairs or permutations of pairs of N items may scale at least exponentially with N, some embodiments may require a set of vectors including n members where n<100). As described herein, in some embodiments, benchmarks may be calculated based on or using generated items already known or assumed “good”, although additional or alternative procedures may be used in different embodiments.

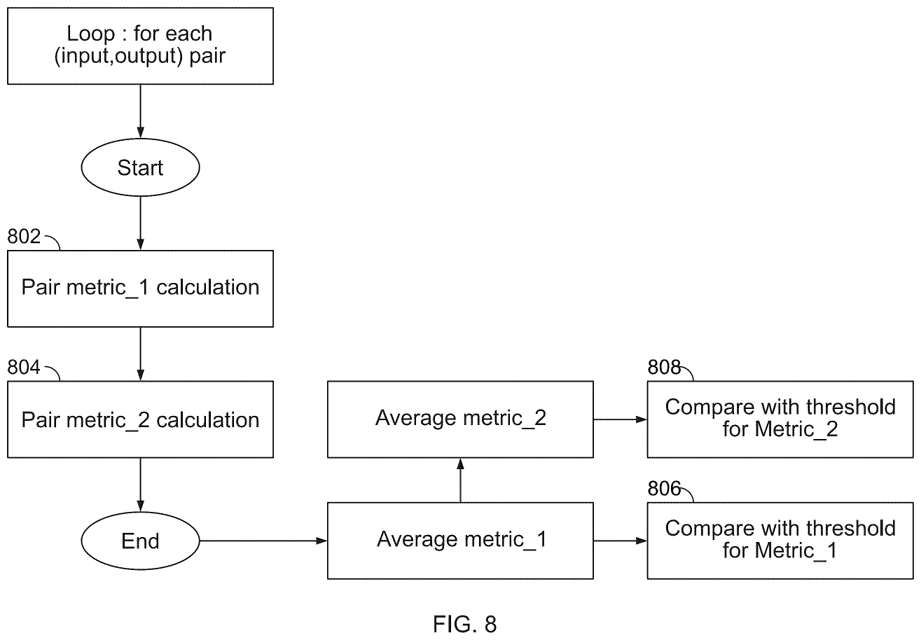

FIG. 8 shows an example evaluation procedure combining different metrics according to some embodiments of the invention.

In some embodiments, Metric_1 (element 802) and Metric_2 (element 804) may be combined or be used together-different metrics or combinations of metrics of them may be used to evaluate items or texts. For example, for a plurality of metrics to be used together, a final or cumulative metric may be calculated as min/max/avg, or as weighted average of the plurality of relevant metrics, and the corresponding threshold or thresholds with which the metrics may be compared may be obtained, for example, as a combination of thresholds set for each of Metric_1 and Metric_2—and may be, e.g., a function of these thresholds, such as for example max (t1,t2), where t1 is the threshold for Metric_1 (element 806) and t2 is the threshold for Metric_2 (element 808); in another example, the combined metric may be compared with each of the thresholds available for the original metrics (prior to their combination). Thresholds may be further adjusted using additional or alternative operations, conditions, or criteria. Additional or alternative metrics, combination of metrics, thresholds, combination of thresholds, and the like, may be used in different embodiments of the invention.

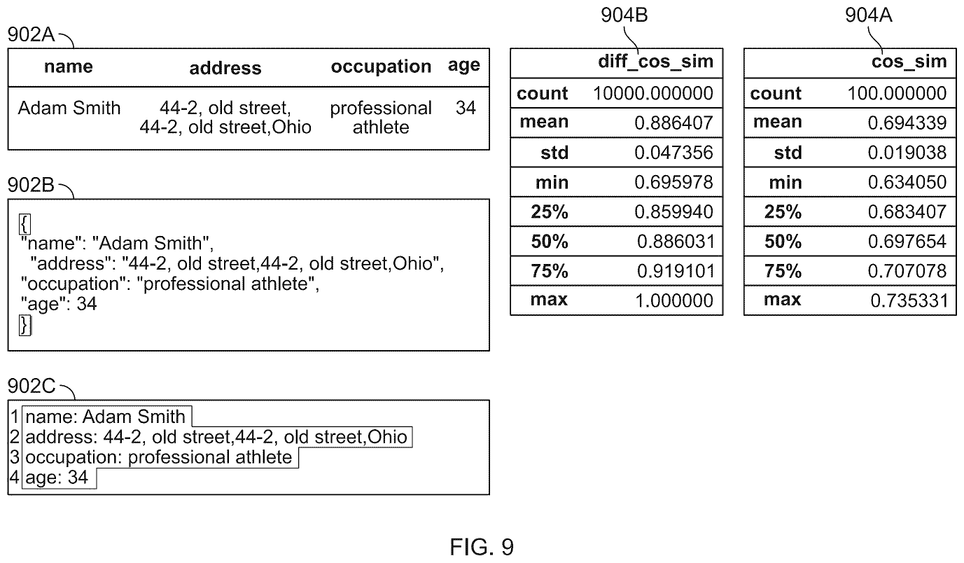

FIG. 9 shows example data structures which may be used by or included in some embodiments of the invention. Example input data items 902A-C may be a database file or entry, which may be for example in a text format, a table format, or a different format (see also Table 1, e.g., for examples of output or generated data items). Example data structures for scores and/or statistics of scores 904A-B calculated according to some embodiments of the invention are also provided. The “count” variable may denote the number of scores or observations considered, and various fields such as “mean”, standard deviation or “std”, “min”, “max”, various percentiles, and the like, may be calculated for these scores or observations. In some embodiments, some statistics of scores may be set or may be used as thresholds or benchmarks, e.g., in operations or evaluations such as for example described herein. Additional or alternative data structures or formats, as well as additional statistical parameters or calculations, may be used in different embodiments of the invention.

In some embodiments of the invention, the input data item is a JavaScript object notation (JSON) item, and wherein the output data item is a text summary of the input data item.

Some example input and output data items according to some embodiments of the invention are provided in Tables 2-3:

```
TABLE 2
Input_json = {
  ‘Case Details': {‘Case Id’: ‘001012012’, ‘Case Open Date’: ‘2014-12-27’},
  ‘Subjects Information’: [{‘Basic Information’: [{‘If All Critical basic information is
  Unavailable’: ‘False’, ‘If Entity’: ‘True’, ‘Role in Suspicious Activity’: ‘Both -
  Receiver/Sender’, ‘Occupation/Type of Business': ‘Student’, ‘Effective Date’: ‘2012-12-
  01’}], ‘Prior SARs': {‘Number of SARs': 2, ‘Total Amount’: 14000, ‘Suspicious Activity
  Types': [‘Money Laundering - Custom money laundering 2’, ‘Fraud - custom fraud’, ‘Money
  Laundering - Custom money laundering’, ‘Fraud - ACH’, ‘Money Laundering - Exchanges
  small bills for large bills or vice versa’, ‘Structuring - Suspicious inquiry by customer
  regarding BSA reporting or recordkeeping requirements', ‘Identification / Documentation
  - Changes spelling or arrangement of name’], ‘Filing Dates': [‘2024-04-09’, ‘2024-04-19’],
  ‘DCNs': [‘dcn_000’, ‘dcn_001’]}, ‘Gender’: ‘Male’, ‘Name of Subject’: [{‘Last Name or Name
  of Entity’: ‘Adam Smith’}], ‘Date of Birth’: ‘01-09-2003’, ‘Addresses': [{‘Address': ‘838
  Broadway’, ‘City’: ‘NEW YORK’, ‘ZIP/Postal Code’: ‘10003’, ‘State’: ‘NY’, ‘State
  Description’: ‘NEW YORK’, ‘Country’: ‘US’, ‘Country Description’: ‘UNITED STATES’}],
  ‘Identifications': [{‘Identification Type’: “Driver's license/State ID”, ‘Identification
  Number’: ‘6244114’, ‘State’: ‘NY’, ‘State Description’: ‘NEW YORK’, ‘Country’: ‘US’,
  ‘Country Description’: ‘UNITED STATES’}], ‘Phone Numbers': [{‘Phone Type’: ‘mobile’,
  ‘Phone Number’: ‘07009367060’}], ‘Relationships to an Institution’: [[‘Customer’,
  ‘employee’, ‘Institution TIN: 123699875’]], ‘Accounts': [{‘Account Number’: ‘33839274’,
  ‘Account Key’: ‘10_169_33839274’, ‘Closed?’: ‘False’, ‘Non-US Financial Institution?’:
  ‘False’, ‘Financial Institution TIN’: ‘123699875’}]}, {‘Basic Information’: [{‘If All Critical
  basic information is Unavailable’: ‘False’, ‘If Entity’: ‘True’, ‘Role in Suspicious Activity’:
  ‘Purchaser/Sender’}], ‘Gender’: ‘Male’, ‘Name of Subject’: [{‘Last Name or Name of Entity’:
  ‘Franklin Sender’}], ‘Relationships to an Institution’: [[‘Customer’, ‘Institution TIN:
  878787878’]], ‘Accounts': [{‘Account Number’: ‘36834540’, ‘Account Key’:
  ‘10_8787_36834540’, ‘Closed?’: ‘False’, ‘Non-US Financial Institution?’: ‘False’, ‘Financial
  Institution TIN’: ‘878787878’}]}, {‘Basic Information’: [{‘If All Critical basic information
  is Unavailable’: ‘False’, ‘If Entity’: ‘True’, ‘Role in Suspicious Activity’:
  ‘Purchaser/Sender’}], ‘Gender’: ‘Female’, ‘Name of Subject’: [{‘Last Name or Name of
  Entity’: ‘Jessica Sender’}], ‘Accounts': [{‘Account Number’: ‘36834550’, ‘Account Key’:
  ‘10_6655_36834550’, ‘Closed?’: ‘False’, ‘Non-US Financial Institution?’: ‘False’, ‘Financial
  Institution TIN’: ‘666655555’}]}, {‘Basic Information’: [{‘If All Critical basic information
  is Unavailable’: ‘False’, ‘If Entity’: ‘True’, ‘Role in Suspicious Activity’:
  ‘Purchaser/Sender’}], ‘Gender’: ‘Male’, ‘Name of Subject’: [{‘Last Name or Name of Entity’:
  ‘James Sender’}], ‘Relationships to an Institution’: [[‘Customer’, ‘Institution TIN:
  121212121’]], ‘Accounts': [{‘Account Number’: ‘777666122’, ‘Account Key’:
  ‘10_1212_777666122’, ‘Closed?’: ‘False’, ‘Non-US Financial Institution?’: ‘False’, ‘Financial
  Institution TIN’: ‘121212121’}]}, {‘Basic Information’: [{‘If All Critical basic information
  is Unavailable’: ‘False’, ‘If Entity’: ‘True’, ‘Role in Suspicious Activity’: ‘Payee/Receiver’}],
  ‘Gender’: ‘Male’, ‘Name of Subject’: [{‘Last Name or Name of Entity’: ‘John Receiver’}],
  ‘Relationships to an Institution’: [[‘Customer’, ‘Institution TIN: 343434343’]], ‘Accounts':
  [{‘Account Number’: ‘666777211’, ‘Account Key’: ‘10_3434_666777211’, ‘Closed?’: ‘False’,
  ‘Non-US Financial Institution?’: ‘False’, ‘Financial Institution TIN’: ‘343434343’}]}],
  ‘Suspicious Activity Information’: [{‘detected date’: ‘2023-10-15’, ‘Suspicious Activity
  Information’: [{‘Has Attachment ’: ‘False’}], ‘Type of report’: [{‘New Report’: ‘True’, ‘Filing
  Institution Note to FinCEN’: ‘Suspicious Activity Report’}], ‘Suspicious Activity’: [{‘Dollar
  Amount Involved in Activity’: ‘85000’, ‘No Amount Involved’: ‘False’}], ‘Date or Date
  Range of Suspicious Activity’: [{‘Date From’: ‘2023-10-10 12:00 am’, ‘Date To’: ‘2023-10-
  15 11:59 pm’}], ‘Instrument Type’: [‘Funds transfer’], ‘Product Type(s) Involved’: [‘wires'],
  ‘Money Laundering’: [‘Transactions out of patterns for customer(s)’, ‘Funnel account’,
  ‘Suspicion concerning the source of funds', ‘Suspicious EFT/Wire tranfers', ‘Money
  Mule’]}],
  ‘Financial Institutions': [{‘Filing Financial Institution’: [{‘Filer Name’: ‘Bank of NEW
  YORK’, ‘TIN’: ‘123699875’, ‘TIN Type’: ‘EIN’, ‘Primary Federal Regulator’: ‘Internal
  Revenue Service (IRS)’, ‘Type of Financial Institution’: ‘Depository Institution’, ‘Other
  Description’: ‘’, ‘Alternative Name’: ‘Bank’}], ‘Type of Securities and Futures Institution’:
  [[‘Financial Institution Identification Type’, ‘Financial Institution Identification Number’,
  ‘Address: 399 103’, ‘City: NEW YORK’, ‘State: NY’, ‘State Description: NEW YORK’,
  ‘Country: US’, ‘Country Description: UNITED STATES’, ‘ZIP/Postal Code: 10043’]],
  ‘Filing Institution Contact Office’: [{‘Filing Institution Contact Office’: ‘Joseph W’, ‘Filing
  Institution Phone Number’: ‘8634307415’}], ‘Financial Institution(s) Where Activity
  Occurred 2B’: [{‘Legal Name of Financial Institution’: ‘Bank of NEW YORK’, ‘TIN’:
  ‘123699875’, ‘TIN Type’: ‘EIN’, ‘Primary Federal Regulator’: ‘Internal Revenue Service
  (IRS)’, ‘Type of Financial Institution’: ‘Depository Institution’, ‘Other Description’: ‘’,
  ‘Financial Institution Location Code’: ‘NY’, ‘Alternative Name’: ‘Bank’, ‘Internal
  Control/File Number’: ‘3635841’, ‘Branches': [{‘Branch or Office Location Code’: ‘149’,
  ‘Branch or Office RSSD Number’: ‘3587146’, “Branch's Role in Transaction”: ‘Both’,
  ‘Address of Branch or Office’: ‘589 Broadway 188’, ‘Branch or Office City’: ‘NEW YORK’,
  ‘Branch or Office State’: ‘NEW YORK’, ‘Branch or Office State Description’: ‘NEW
  YORK’, ‘Branch or Office Country’: ‘US’, ‘Branch or Office Country Description’:
  ‘UNITED STATES’, ‘Branch or Office ZIP/Postal Code’: ‘10012’}]}, {‘Legal Name of
  Financial Institution’: ‘Bank of Florida’, ‘TIN’: ‘878787878’, ‘TIN Type’: ‘EIN’, ‘Primary
  Federal Regulator’: ‘Internal Revenue Service (IRS)’, ‘Type of Financial Institution’:
  ‘Depository Institution’, ‘Other Description’: ‘’, ‘Financial Institution Location Code’: ‘FL’,
  ‘Branches': [ ]}, {‘Legal Name of Financial Institution’: ‘PNC Bank’, ‘TIN’: ‘666655555’,
  ‘TIN Type’: ‘EIN’, ‘Primary Federal Regulator’: ‘Internal Revenue Service (IRS)’, ‘Type of
  Financial Institution’: ‘Depository Institution’, ‘Other Description’: ‘’, ‘Financial Institution
  Location Code’: ‘NY’, ‘Branches': [ ]}, {‘Legal Name of Financial Institution’: ‘keyBank’,
  ‘TIN’: ‘121212121’, ‘TIN Type’: ‘EIN’, ‘Primary Federal Regulator’: ‘Internal Revenue
  Service (IRS)’, ‘Type of Financial Institution’: ‘Depository Institution’, ‘Other Description’:
  ‘’, ‘Financial Institution Location Code’: ‘NY’, ‘Branches': [ ]}, {‘Legal Name of Financial
  Institution’: ‘Bank of America’, ‘TIN’: ‘343434343’, ‘TIN Type’: ‘EIN’, ‘Primary Federal
  Regulator’: ‘Internal Revenue Service (IRS)’, ‘Type of Financial Institution’: ‘Depository
  Institution’, ‘Other Description’: ‘’, ‘Financial Institution Location Code’: ‘NY’, ‘Branches':
  [ ]}]}],
  ‘Related transactions': [{‘Key’: ‘t2_1007652’, ‘Amount’: 5000, ‘Quantity’: 1, ‘Date’: ‘2023-
  10-10T00:00’, ‘Type’: ‘Incoming high risk fund transfers', ‘Execution Branch’: ‘149’,
  ‘Counterparty Account Number’: 36834540, ‘Counterparty FI’: ‘Bank of Florida’,
  ‘Originator Name’: ‘Franklin Sender’, ‘Beneficiary Name’: ‘Adam Smith’}, {‘Key’:
  ‘t2_1001331’, ‘Amount’: 7000, ‘Quantity’: 1, ‘Date’: ‘2023-10-11T00:00’, ‘Type’: ‘Incoming
  high risk fund transfers', ‘Execution Branch’: ‘149’, ‘Counterparty FI’: ‘Bank of Florida’,
  ‘Counterparty Account Number’: 36834540, ‘Originator Name’: ‘Franklin Sender’,
  ‘Beneficiary Name’: ‘Adam Smith’}, {‘Key’: ‘t2_1004782’, ‘Amount’: 6000, ‘Quantity’: 1,
  ‘Date’: ‘2023-10-12T00:00’, ‘Type’: ‘Incoming high risk fund transfers', ‘Execution Branch’:
  ‘149’, ‘Counterparty FI’: ‘Bank of Florida’, ‘Counterparty Account Number’: 36834540,
  ‘Originator Name’: ‘Franklin Sender’, ‘Beneficiary Name’: ‘Adam Smith’}, {‘Key’:
  ‘t2_2000025’, ‘Amount’: 8000, ‘Quantity’: 1, ‘Date’: ‘2023-10-10T00:00’, ‘Type’: ‘Incoming
  high risk fund transfers', ‘Execution Branch’: ‘149’, ‘Counterparty FI’: ‘PNC Bank’,
  ‘Counterparty Account Number’: 36834550, ‘Originator Name’: ‘Jessica Sender’,
  ‘Beneficiary Name’: ‘Adam Smith’}, {‘Key’: ‘t2_2012306’, ‘Amount’: 9000, ‘Quantity’: 1,
  ‘Date’: ‘2023-10-11T00:00’, ‘Type’: ‘Incoming high risk fund transfers', ‘Execution Branch’:
  ‘149’, ‘Counterparty FI’: ‘PNC Bank’, ‘Counterparty Account Number’: 36834550,
  ‘Originator Name’: ‘Jessica Sender’, ‘Beneficiary Name’: ‘Adam Smith’}, {‘Key’:
  ‘t2_2012319’, ‘Amount’: 8000, ‘Quantity’: 1, ‘Date’: ‘2023-10-12T00:00’, ‘Type’: ‘Incoming
  high risk fund transfers', ‘Execution Branch’: ‘149’, ‘Counterparty FI’: ‘PNC Bank’,
  ‘Counterparty Account Number’: 36834550, ‘Originator Name’: ‘Jessica Sender’,
  ‘Beneficiary Name’: ‘Adam Smith’}, {‘Key’: ‘t2_3003431’, ‘Amount’: 10000, ‘Quantity’: 1,
  ‘Date’: ‘2023-10-10T00:00’, ‘Type’: ‘Incoming high risk fund transfers', ‘Execution Branch’:
  ‘149’, ‘Counterparty FI’: ‘keyBank’, ‘Counterparty Account Number’: 777666122,
  ‘Originator Name’: ‘James Sender’, ‘Beneficiary Name’: ‘Adam Smith’}, {‘Key’:
  ‘t2_3132322’, ‘Amount’: 11000, ‘Quantity’: 1, ‘Date’: ‘2023-10-11T00:00’, ‘Type’: ‘Incoming
  high risk fund transfers', ‘Execution Branch’: ‘149’, ‘Counterparty FI’: ‘keyBank’,
  ‘Counterparty Account Number’: 777666122, ‘Originator Name’: ‘James Sender’,
  ‘Beneficiary Name’: ‘Adam Smith’}, {‘Key’: ‘t2_3232132’, ‘Amount’: 10000, ‘Quantity’: 1,
  ‘Date’: ‘2023-10-11T00:00’, ‘Type’: ‘Incoming high risk fund transfers', ‘Execution Branch’:
  ‘149’, ‘Counterparty FI’: ‘keyBank’, ‘Counterparty Account Number’: 777666122,
  ‘Originator Name’: ‘James Sender’, ‘Beneficiary Name’: ‘Adam Smith’}, {‘Key’:
  ‘t2_3231231’, ‘Amount’: 11000, ‘Quantity’: 1, ‘Date’: ‘2023-10-12T00:00’, ‘Type’: ‘Incoming
  high risk fund transfers', ‘Execution Branch’: ‘149’, ‘Counterparty FI’: ‘keyBank’,
  ‘Counterparty Account Number’: 777666122, ‘Originator Name’: ‘James Sender’,
  ‘Beneficiary Name’: ‘Adam Smith’}, {‘Key’: ‘t2_4231932’, ‘Amount’: 80000, ‘Quantity’: 1,
  ‘Date’: ‘2023-10-15T00:00’, ‘Type’: ‘Outgoing high risk fund transfers', ‘Execution Branch’:
  ‘149’, ‘Counterparty FI’: ‘Bank of America’, ‘Counterparty Account Number’: 666777211,
  ‘Originator Name’: ‘Adam Smith’, ‘Beneficiary Name’: ‘John Receiver’}]
}
```

//The generation service or generative model may take the input in json format and create a SAR narrative, which may be for example a JSON or text file.

TABLE 3
Generated_text =
This is an initial Suspicious Activity Report (SAR) filed by the Bank of NEW YORK. The
report concerns suspicious activity involving Adam Smith, Franklin Sender, Jessica
Sender, James Sender, and John Receiver. The suspicious activity occurred between
October 10, 2023, and October 15, 2023, and involved approximately $85,000. The
suspicious activity patterns include the use of a funnel account, suspicious electronic fund
transfers/wire transfers, concerns about the source of funds, transactions out of patterns for
the customer(s), and the involvement of a money mule.
The financial institution has filed two prior Suspicious Activity Reports (SARs) on the
primary suspect, Adam Smith, totaling $14,000 in suspicious transactions. The SARs were
filed on April 9, 2024 (DCN: dcn_000) and April 19, 2024 (DCN: dcn_001), and they
detail a range of suspicious activities, including money laundering, fraud, and structuring
transactions to avoid reporting requirements. The institution has reported these activities
to assist in the ongoing financial crime investigation.
Case file 001012012 was opened on 2014-12-27 following an enhanced due diligence
follow-up review of the accounts which resulted in escalation for further investigation. The
suspicion was confirmed on <SUSPICION_CONFIRMATION_DATE>
Adam Smith is a male student who was born on 01-09-2003. Adam Smith has a relationship
with the Bank of NEW YORK as both a customer and an employee, which was established
on 2012-12-01.
Franklin Sender is a male who has a relationship with the Bank of Florida as a customer.
Jessica Sender is a female.
James Sender is a male who has a relationship with keyBank as a customer.
John Receiver is a male who has a relationship with the Bank of America as a customer.
The suspicious activity involves a series of high-risk fund transfers totaling $85,000 into
Adam Smith's account at the Bank of NEW YORK over a five-day period. These transfers
originated from the accounts of Franklin Sender, Jessica Sender, and James Sender at other
financial institutions, including Bank of Florida, PNC Bank, and keyBank. The large and
rapid influx of funds from multiple third-party sources, coupled with Adam Smith's prior
history of suspicious activity, raises concerns about potential money laundering or other
illicit financial schemes.
Adam Smith's profile as a student does not typically align with the scale and nature of these
transactions, further heightening the suspicion. The filing institution has identified several
red flags, including transactions out of patterns for the customer, the use of funnel accounts,
and suspicious electronic fund transfers. Additionally, Adam Smith has been the subject of
two previous Suspicious Activity Reports (SARs) involving money laundering and fraud-
related activities.
For additional information, the Filing Institution Contact Office, Joseph W, can be reached
at 8634307415.

Additional or alternative example data items may be used or included in different embodiments.

Outputs and/or quality metrics produced according to some embodiments of the invention may be used for example for determining if the text needs to be re-generated/improved, or if the text is of insufficient quality. Different conditions or criteria may be used in combination with metric values or weighted metrics. If the text needs to be improved or re-generated, embodiments may for example automatically generate a new output text or summary for the relevant input, and may calculate the relevant metrics for the newly generated text. This may be performed in an interactive manner, for example until an output of a desirable level of quality is produced.

In some embodiments, calculated metrics may be presented on a user interface and/or transmitted to a remote computer system, to allow a user or system administrator to make manual determinations regarding, e.g., whether or not the relevant output should be used or discarded, whether the input data item should be edited or altered and then provided again to generate a different output, whether different prompts to the machine learning model or LLM should be used instead of existing ones, and the like.

In some embodiments, calculated metrics calculated for many generated texts may be accumulated or stored and analyzed to assess the performance of the generation service, machine learning model or LLM. If the performance is not satisfactory (e.g., if metric values, or statistics for calculated metrics for a given time period show lower metric values or deteriorate over time—for example if the average metric value gets lower and lower on 3 subsequent days), some embodiments may allow adjusting or improving generative components (such as, e.g., the prompts and the relevant machine learning models) based on stored or analyzed past metrics or evaluations.

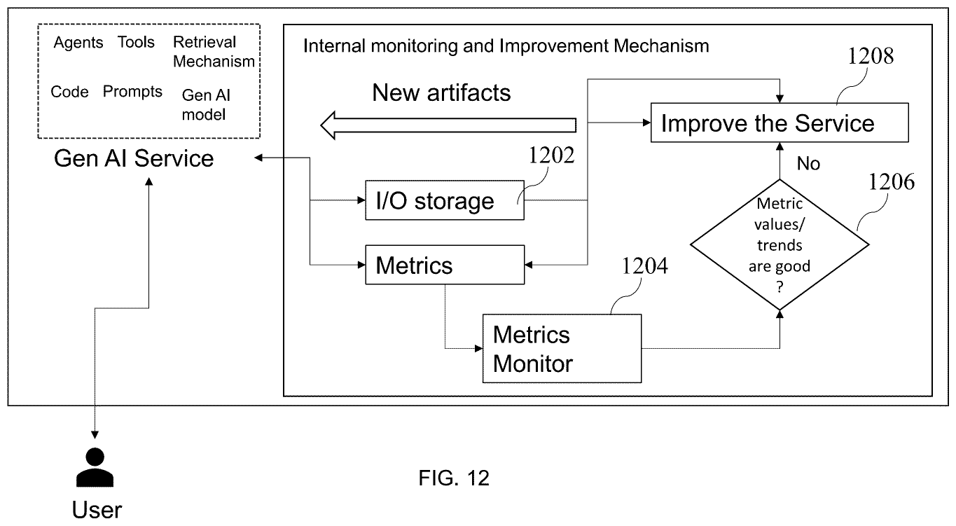

Some embodiments may, for example, consider, select, determine, or update prompts to Gen AI models and/or AI agents, as well as specific instructions within prompts or a general prompting strategy used to prompt or query an LLM or GenAI model. Some embodiments may include fine-tuning or retraining the relevant model, LLM or GenAI model using generated data items or outputs that may be labeled or scored, e.g., as part of a supervised learning procedure or algorithm. Some embodiments may include refining or retraining different tools or mechanisms available to different AI agents, e.g., individually or in combination. FIG. 12 shows an example monitoring and improvement mechanism according to some embodiments of the invention.

In some embodiments, an improvement mechanism or workflow may include calculating metrics, storing the metrics in a dedicated database (e.g., in an I/O storage component 1202); an example database may include, for example, a set of calculated metric values and a set of time values or periods as time-value pairs, such as, e.g., {(10:00, 0.75), (10:10, 0.78), (10:20, 0.98), . . . } and the like, where the first value in a pair may indicate a time at which the metric is computed, and the second value may be the calculated metric value. Additional or alternative metric database formats may be used in different embodiments. Some embodiments may monitor the database of calculated metrics, for example once in a predetermined time interval (e.g., once in 5 minutes, or once in 1 day; element 1204). Some embodiments may then check if metric values, or if a trend for the calculated metrics, are “good” or “bad” (element 1206): for example, metric values above a threshold value of 0.7 may be determined as “good”, and below 0.7 may be determined as “bad”. Additionally or alternatively, a trend in metric values where consecutive metric values for a given time period (e.g., 1 day) increase, or do not decrease over time may be determined “good”—and a trend were consecutive metric values for a given time period decrease over time may be determined “bad”. In case metric values are not good, or are bad, some embodiments may improve the corresponding GenAI service and/or model according to various improvement strategies and appropriate procedures, protocols, and operations (element 1208).

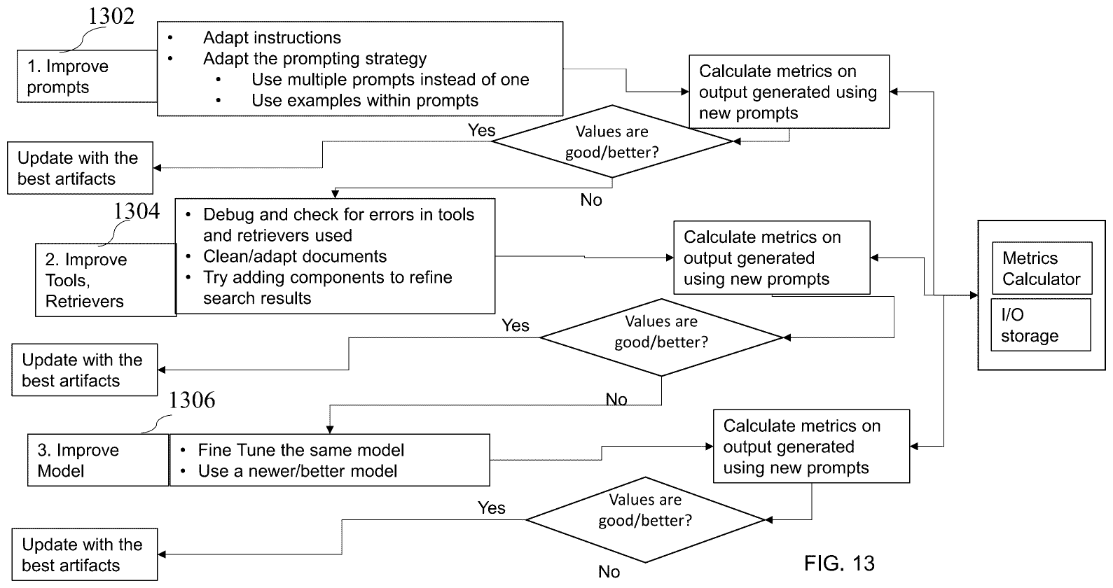

FIG. 13 shows an example generative artificial intelligence (GenAI) model service improvement process according to some embodiments of the invention.

In some embodiments, an example improvement process may include a plurality of steps such as for example improving prompts and/or prompting strategies (element 1302), improving GenAI tools and/or retrievers (element 1304), and improving, refining, fine tuning or retraining the relevant LLM or GenAI model (element 1306).

For example, based on monitored values in a database of calculated metric values such as e.g., a “bad” trend in calculated metric values (e.g., metric values decrease over time for a time period of a day) for outputs or texts generated using a prompt p=[generate human readable summary for the attached executable file:]-some embodiments may add a predetermined instruction, such as for example i=[where the summary should not exceed 150 words], to prompt p—in order to improve prompts or prompting strategies (element 1302). Embodiments may then calculate a plurality of metric values and, e.g., in case metric values or trends are “good”—may continue to use the modified or updated prompt p+i in future generation operations.

In a similar manner, and to provide further improvements (e.g., if metric values or trends are still not “good”) some embodiments may switch between different options or alternatives (which may for example be predetermined and/or configurable) for, e.g.:
Document preprocessing or cleaning procedures;
Automatic debugging protocols or procedures (which may be used, e.g., to prevent errors by various generative tools available to different AI agents and/or as part of a GenAI component or service);
Retrievers or information retrieving tools such as for example search engines or protocols for using or refining search results (e.g., in example embodiments where results by a search engine may be used in the output data item generation process);
and, for a given option, calculate a plurality of metric values, and determine if the values or a trend of values is “good” or “bad”, and use an option for which the values/trend are “good” (e.g., in element 1304).

Some embodiments may include training the machine learning model based on one or more metric values in a database of calculated metric values, wherein the output data item is generated using the trained machine learning model.

For example, based on monitored values in a database of calculated metric values which may describe e.g., a “bad” trend in calculated metric values for outputs or texts generated using a given LLM or GenAI model (e.g., metric values decrease over time for a time period of a day)—and in order to provide further improvements-some embodiments may train, retrain, refine or fine-tune the machine learning model, including relevant GenAI or LLM components (element 1306), for example using a reinforcement learning procedure and using labeled data. In some embodiments, retraining or fine tuning may be performed, e.g., using output data items labeled or scored (e.g., manually or by a human user) to provide reward or penalty values to a relevant LLM or GenAI model (e.g., using an appropriate reward or penalty function) and to indicate their correspondence or similarity to input or counterpart data items. Embodiments may calculate a plurality of metric values for output values generated using the trained or retrained model and, e.g., in case metric values or trends are “good”-embodiments may continue to use the trained or retrained model for future generation operations, and may for example use output data items generated using the trained or retrained model in subsequent operations (such as for example transmitting generated data items to a remote computer, and the like). Additional or alternative retraining, refining, or fine tuning approaches or techniques may be used in different embodiments.

In some embodiments, GenAI or LLM performance improvement procedures, processes, or subprocesses may be implemented in a conditional or serial manner. For example, some embodiments may first attempt to improve prompts or a prompting strategy (e.g., according to element 1302). If an improvement is not achieved (e.g., if metric values or trends are not “good” using any alternative among a plurality of possible prompts/instructions or combinations of prompts/instructions)—embodiments may attempt to improve tools and retrievers (e.g., according to element 1304). If an improvement is still not achieved, embodiments may attempt to improve the model itself (e.g., according to element 1306). Upon achieving an improvement (e.g., if metric values or a trend of values are/is “good”), embodiments may stop the improvement process and, e.g., not proceed to perform subsequent operations or elements in the process. In such manner, embodiments may avoid requiring significant computational cost for GenAI component or service improvement, as computationally costly processes such as, e.g., GenAI model training or retraining (which may include optimizing a large number of coefficients or factors along different neural network layers) may be avoided if performance improvement may be achieved in less costly ways.

Additional or alternative model or service improvement protocols may be used in different embodiments of the invention.

Some embodiments may include performing an exchange of data between remotely connected computer systems based on a comparison of the computed similarity value to a benchmark similarity value.

For example, some embodiments may transmit a data item such as for example an alert and/or report, which may for example include output data items or summaries provided by a GenAI model or LLM for which scores above a threshold value (e.g., of 0.8) were calculated—e.g., to one or more computer systems remotely connected over a network (such as for example one of the systems or components described with regard to FIG. 2). In this context, generated or output items may be compared to input items for example by calculating or computing embeddings for the items and calculating similarity scores or metrics using the embeddings for the items—and an output item for which scores above a threshold may be sent or transmitted to a remote computer as part of an exchange of data over a communication network between computerized systems.

items for which scores above a threshold value may be considered to be of sufficient quality, and

Some embodiments may send or transmit computerized requests or commands based on which computerized and/or automated actions may be taken-such as for example commands for updating or retraining a GenAI model or LLM based on performance metrics or scores such as, e.g., described herein. Additional or alternative automated computerized actions may be taken based on computerized request or commands and/or using additional conditions or criteria, may be used in different embodiments.

In some embodiments, based on calculated metrics and/or according to corresponding performance evaluations of GenAI models or LLMs, different prompts or prompting strategies may be used to generate output data items by embodiments of the invention. For example, some embodiments may include evaluating a plurality of strategies or procedures to generate outputs, which may be used to generate a plurality of outputs such as text data items. Some embodiments may calculate metrics for different outputs produced using different prompts or prompting strategies or schemes, and select the best performing prompt/strategy for future use and generating additional data items using the relevant GenAI model. In some embodiments, multiple prompts or prompting strategies may be evaluated by using the different prompts or strategies to generate outputs and then evaluating the outputs using calculated metrics. In some embodiments the strategy or prompt with the best metric values (which may include the highest similarity values between inputs and outputs among the strategies or prompts considered) may be selected as the best strategy or as a strategy for future output item generation operations. Similarly, some embodiments may provide improvements using to LLM technology by evaluating outputs prior or subsequent to changes made to the generative system, including changes to different model or AI agent tools, processing or cleaning operations, model retraining or fine-tuning operations, and the like. In some embodiments, metrics may be used to evaluate automatically generated prompts or variations of prompts, for example by calculating metrics for outputs automatically generated using the automatically generated prompts or variations.

Some example embodiments of the invention may relate to financial crime alert investigation services (e.g., in financial institutions such as banks) where the generation service or machine learning model may be used to create suspicious activity report (SAR) narratives. A SAR may be or may include a text item or file describing the details of suspects and/or of suspicious activity detected or found by relevant fraud detection technologies or systems. It is noted, however, that different embodiments of the invention may be used in different fields and/or contexts, such as for example generating summaries of user details and activities in various software systems, summaries of software executables, of contents of online web pages, of financial or numeric data, of environmental, social, and governance (ESG) data of corporations, and the like.

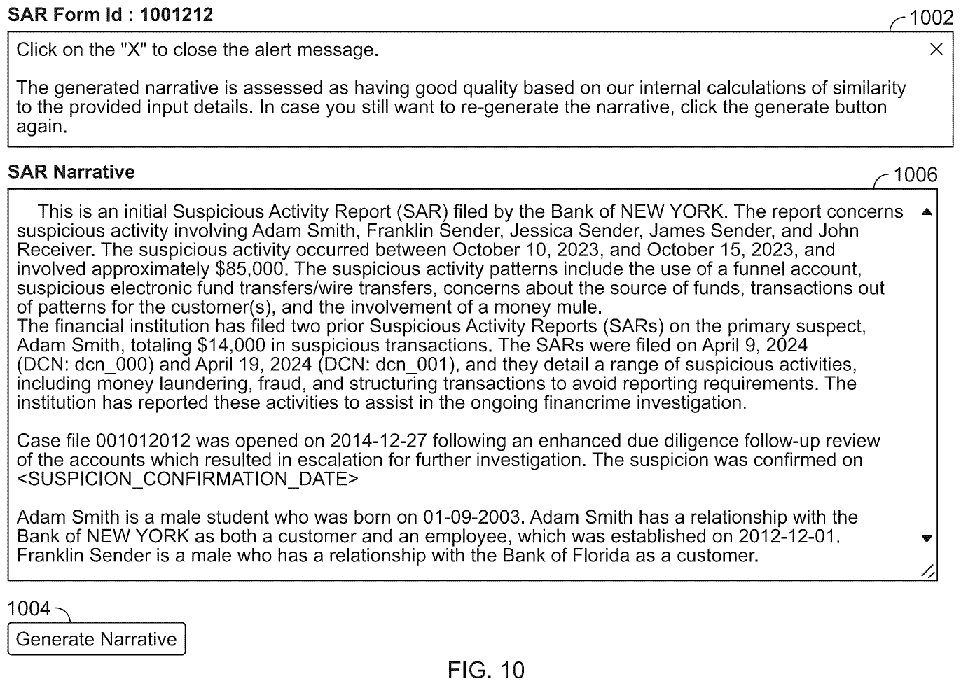

FIG. 10 shows an example user interface for generating suspicious activity reports according to some embodiments of the invention.

In some embodiments, the output data item is a suspicious activity report.

In some embodiments, a user interface (which may be constructed, for example, using the ActOne framework; element 1002) may be displayed on a computer display or output device and may be operated by a user, such as for example a system administrators or suspicious activity investigator. The user may provide an input data item, which may be a relevant database file or files (e.g., using a link or a drag-and-drop box), and may for example click on a “generate” button (element 1004) to generate an output data item or summary such as for example a SAR narrative (element 1006) using a machine learning model, LLM, or GenAI model such as described herein. Some embodiments may automatically calculate scores or metrics such as, e.g., described herein for the generated output item—and if the output item is considered “bad” (e.g., if the scores or metrics are below corresponding benchmarks or thresholds), embodiments may automatically discard the output item and generate a new, different output item instead. This may be done iteratively, e.g., until an output item of sufficient quality (e.g., having calculated scores or metrics above the relevant thresholds and conforming to relevant benchmarks and/or requirements) is generated or produced. When an output item is considered “good” according to relevant metrics or scores, embodiments may provide the output item to the user via the UI. In case the user is dissatisfied with the received output item, the user may click on the “generate” button again to generate a replacement or substitute narrative such as described herein.

Additional or alternative procedures and/or interfaces for generating SARs may be used in different embodiments of the invention.

In some embodiments, the exchange of data comprises transmitting the suspicious activity report to a remote computer system.

Some embodiments may use quality metrics such as for example described herein, e.g., as feedback to the generation process and to determine whether a generated SAR should be discarded, re-generated, and/or sent or transmitted to a remote or physically separate computer system, e.g., over a communication network. In one nonlimiting example, metrics (e.g., calculated for a plurality of SARs) may be displayed on a user interface or a dashboard for users, such as for example security agents in financial institutions, and/or system administrators or developers. Statistics of metrics such as for example avg, min, median of the metrics may be used to assess or analyze the performance of the relevant generation process, machine learning model, and the like, and/or to assess or analyze specific generated SARs. Based on the metrics and/or their statistics, users may decide whether to perform an exchange or data, such as for example send or transmit a given SAR to a different user or computing device (such as for example a device associated with an account for which suspicious activity may have been performed) and/or try to adjust or improve the machine learning model, use different prompting strategies, and the like, such as for example described herein.

Some embodiments of the invention may improve technology by streamlining data generation by machine learning models, LLMs, and GenAI models—e.g., by seamlessly evaluating generated data items and by automatically and seamlessly keeping or discarding data items based on evaluation results. In addition, metrics calculated for a plurality of generated items over time according to some embodiments may be used for identifying weak points in the generative model or LLM (which may be, e.g., a translation model), and for example for planning or adjusting a training process for the model to improve or enhance the model's accuracy over time. Evaluation results according to some embodiments may thus improve machine learning technology and enable the creation of adaptive machine learning systems that may adjust their parameters (e.g., in real-time) to maintain robust output data standards and/or quality.

Some embodiments of the invention may improve various additional technologies unrelated to human readable text. For example, some embodiments may be used for generating large volumes of synthetic data for training LLMs and/or GenAI models, where, e.g., a large volume of text data items may be required to conform to quality or consistency standards (as may be verified or guaranteed, e.g., using metrics as described herein).

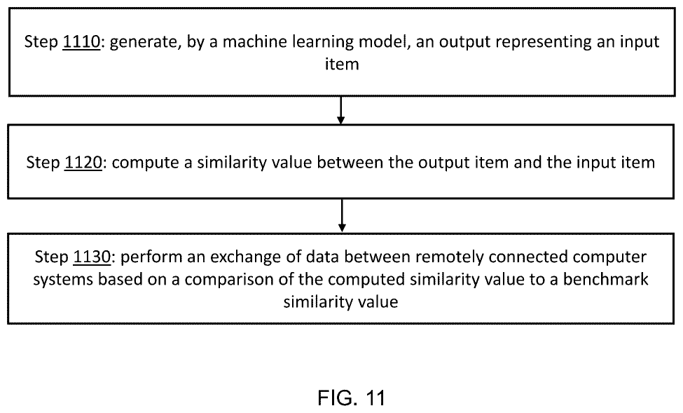

FIG. 11 is a flowchart showing an example process for evaluating data items generated using a machine learning model according to some embodiments of the invention. In operation 1110, some embodiments may include generating, by a machine learning model, an output data item (such as for example a text description or summary, such as for example a SAR narrative) based on an input data item (such as for example a structured database or tabular data entry, which may be, e.g., human unreadable), where the output item represents the input item (and may be, e.g., a textual summary or description of the input). Some embodiments may include computing a similarity value between the output item and the input item (operations 1120), and performing an exchange of data between remotely connected computer systems (such as for example sending a SAR and/or additional or alternative data elements or items) based on a comparison of the computed similarity value to a benchmark similarity value or to a threshold metric value (operation 1130). Additional or alternative operations may be included in different embodiments.

One skilled in the art will realize the invention may be embodied in other specific forms without departing from the spirit or essential characteristics thereof. The embodiments described herein are therefore to be considered in all respects illustrative rather than limiting. In detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention.

Embodiments may include different combinations of features noted in the described embodiments, and features or elements described with respect to one embodiment or flowchart can be combined with or used with features or elements described with respect to other embodiments.

Although embodiments of the invention are not limited in this regard, discussions utilizing terms such as, for example, “processing,” “computing,” “calculating,” “determining,” “establishing”, “analyzing”, “checking”, or the like, can refer to operation(s) and/or process(es) of a computer, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

1. A method of automatically tuning a machine learning model by evaluating machine learning generated data items, the method comprising, using a computer processor:
generating, by a machine learning model, an output data item based on an input data item, the output item representing the input item:
computing a similarity value between the output item and the input item:
performing an exchange of data between remotely connected computer systems based on a comparison of the computed similarity value to a benchmark similarity threshold; and
tuning the machine learning model using a plurality of output data items including the output data item, the plurality of output data items generated by the machine learning model, wherein the plurality of output data items are labeled to indicate a similarity to a corresponding plurality of counterpart data items input to the machine learning model.

2. The method of claim 1, wherein the computing of a similarity value comprises calculating a cosine similarity between a vector representation of the output data item and a vector representation of the input data item.

3. The method of claim 1, wherein the computing of a similarity value comprises:
computing a difference vector between a vector representation of the output item and a vector representation of the input item:
wherein the similarity value is computed as a function of a plurality of similarities of the computed difference vector to each of a plurality of reference vectors.

4. The method of claim 1, wherein the input data item is a JavaScript object notation (JSON) item, and wherein the output data item is a text summary of the input data item.

5. The method of claim 1, wherein the output data item is a suspicious activity report, and wherein the exchange of data comprises transmitting the suspicious activity report to a remote computer system.

6. The method of claim 1, wherein the input data item comprises a structured database entry, and wherein the generating of an output data item based on an input data item comprises adding a predefined context prompt to the database entry.

7. The method of claim 1, comprising training the machine learning model based on one or more metric values in a database of calculated metric values, wherein the output data item is generated using the trained machine learning model.

8. A computerized system for automatically evaluating machine learning generated data items, the system comprising:
a memory; and
one or more processors configured to:
generate, by a machine learning model, an output data item based on an input data item, the output item representing the input item:
compute a similarity value between the output item and the input item:
perform an exchange of data between remotely connected computer systems based on a comparison of the computed similarity value to a benchmark similarity threshold; and
tune the machine learning model using a plurality of output data items including the output data item, the plurality of output data items generated by the machine learning model, wherein the plurality of output data items are labeled to indicate a similarity to a corresponding plurality of counterpart data items input to the machine learning model.

9. The system of claim 8, wherein the computing of a similarity value comprises calculating a cosine similarity between a vector representation of the output data item and a vector representation of the input data item.

10. The system of claim 8, wherein the computing of a similarity value comprises:
computing a difference vector between a vector representation of the output item and a vector representation of the input item:
wherein the similarity value is computed as a function of a plurality of similarities of the computed difference vector to each of a plurality of reference vectors.

11. The system of claim 8, wherein the input data item is a JavaScript object notation (JSON) item, and wherein the output data item is a text summary of the input data item.

12. The system of claim 8, wherein the output data item is a suspicious activity report, and wherein the exchange of data comprises transmitting the suspicious activity report to a remote computer system.

13. The system of claim 8, wherein the input data item comprises a structured database entry, and wherein the generating of an output data item based on an input data item comprises adding a predefined context prompt to the database entry.

14. The system of claim 8, wherein one or more of the processors are configured to train the machine learning model based on one or more metric values in a database of calculated metric values, and wherein the output data item is generated using the trained machine learning model.

15. A method of automatically tuning a generative artificial intelligence (GenAI) model by assessing textual data items generated using GenAI by, the method comprising, using a computer processor:
producing, by a GenAI model, an output text based on an input data item, the output item representing the input item, wherein the input item comprises non-textual data:
calculating a similarity metric between the output text and the input item:
performing an exchange of data between remotely connected computer systems over a communication network based on a comparison of the calculated similarity metric to one or more predetermined threshold values; and
tuning the GenAI model using a plurality of output texts including the output text, the plurality of output texts generated by the GenAI model, wherein the plurality of output texts are labeled to indicate a similarity to a corresponding plurality of counterpart data items input to the GenAI model.

16. The method of claim 15, wherein the calculating of a similarity metric comprises calculating a cosine distance between a vector embedding of the output text and a vector embedding of the input data item.

17. The method of claim 15, wherein the calculating of a similarity metric comprises:
calculating a difference vector between a vector embedding of the output text and a vector embedding of the input item:
wherein the similarity metric is calculated as a function of a plurality of similarities of the computed difference vector to each of a plurality of benchmark vectors.

18. The method of claim 15, wherein the input data item is a structured dataset entry, and wherein the output text is a description of the input data item.

19. The method of claim 15, wherein the output text is a suspicious activity report, and wherein the exchange of data comprises sending the suspicious activity report to a remote computer.

20. The method of claim 18, wherein the producing of an output text based on an input data item comprises adding an explanation prompt to the database entry.

21. The method of claim 1, comprising: automatically discarding the output item if the computed similarity value is below the benchmark similarity threshold:
generating, by the machine learning model, one or more new output items, the new output items different from the output item, the generating of the new output items being performed until a similarity value above the benchmark similarity threshold is calculated for a new output item of the one or more new output items; and
providing the new output item having the similarity value above the benchmark similarity threshold via a user interface (UI).
